(19) United States
(12) Patent Application Publication
(10) Pub. No.: US 2020/0269944 A1
(43) Pub. Date: Aug. 27, 2020

(54) LUGGAGE STABILIZER SYSTEM AND METHOD

(71) Applicant: Dragonfly Brands Corporation, Greensboro, NC (US)

(72) Inventors: Glen Laivins, Jamestown, NC (US); Ken Laivins, Jamestown, NC (US); Mario Michael Galasso, Newtown, CT (US)

(73) Assignee: Dragonfly Brands Corporation, Greensboro, NC (US)

(21) Appl. No.: 16/799,513

(22) Filed: Feb. 24, 2020

Related U.S. Application Data
(60) Provisional application No. 62/808,994, filed on Feb. 22, 2019.

(51) Int. Cl. B62J 9/27

(52) U.S. Cl. CPC B62J 9/27

(57) ABSTRACT

A luggage stabilization system is disclosed system that stabilizes and protects a piece of luggage when it is temporarily removed from a vehicle and placed on a horizontal surface. The stabilization system is positioned on the bottom side of the piece of luggage and is configured to prevent the luggage from contacting the horizontal surface and to stabilize the luggage laterally and rotationally. Methods for retrofitting a piece of luggage for a vehicle is also disclosed.

### BACKGROUND OF THE DISCLOSURE

### Field of the Disclosure

Embodiments of the present disclosure relate to luggage stabilizers in general and more particularly to saddle bag stabilizers to be used in combination with vehicle detachable saddle bags.

### Description of the Related Art

Open air wheeled vehicles such as motorcycles, mopeds, or bicycles are often provided with attachments points to fasten luggage or carrying cases for transporting items while the wheeled vehicle is in use. These luggage bags, commonly referred to as saddle bags, are provided with detachable fastening systems such as quarter turn fasteners and threaded fasteners for engaging with and securing the saddle bags to the attachment points on the wheeled vehicle. These saddle bags can come in many construction types from soft fabric construction, to leather construction, to various forms of hard material construction. Hard material saddle bags are finished on the outside aesthetic surfaces with paint and other acrylic finishes. Many times, the painted outside surfaces are color matched to other painted surfaces on the vehicle such as the fuel tank and front and rear fenders. Even when the saddle bags are not color matched to other painted surfaces of the vehicle, they still generally have an aesthetically pleasing painted surface and color that complements the other painted surfaces of the vehicle.

There are many situations that necessitate temporary removal of the saddle bags from the vehicle. Some such situations include cleaning the vehicle, checking the tire pressure of and adding or removing air pressure from the vehicle rear tires, or checking and making adjustments to the rear suspension elements of the vehicle. Temporary storage of the saddle bags in such situations can have deleterious effects to the saddle bags. For example, setting the detachable saddle bags on a convenient surface can scratch and otherwise damage the bottom surface of the detachable luggage/saddle bags unless something is put between the surface intended to set the saddle bags on, and the saddle bags themselves. Additionally, the saddle bags typically have a bottom surface shape that is contoured, for example to avoid vehicle components such as exhaust systems, and not designed to allow the saddle bags to sit stably on a flat surface. In these situations, the saddle bags are at risk of falling over and becoming damaged if set on the contoured bottom surfaces. Further, if the bottom surface of the saddle bags have been protected by putting down something, like a pad, cloth or blanket, between the saddle bags and the surface it will sit on, the balance point of the saddle bag can be altered even further, making it more likely to become unstable and get damaged due to falling over.

One solution to avoiding laying saddle bags on the ground for temporary storage of a removable saddle bag is a rack system such as that disclosed in U.S. Pat. No. D607664. There are many similar such rack systems that are commercially available such as the Saddlebag Storage Stand disclosed at the following link: www.harley-davidson.com/store/saddlebag-storage-stand. The disclosure outlines the aforementioned problems of temporary storage of the saddle bags but the embodiment disclosed is not a practical solution, for several reasons. For instance, such saddle bag storage stands are geared more towards long term storage, or for temporary use when in a garage or workshop as it is not possible to efficiently store and travel with such a device, making field usage impractical.

What is needed is safe, efficient and portable stabilizing system for a removable vehicle luggage.

### SUMMARY OF THE INVENTION

It is the intention of the present invention to provide a saddle bag stabilizer that is easily and intuitively installed to the bottom surface of a saddle bag. The saddle bag stabilizer can provide a flat, larger cross sectional area to the base of the saddle bag once installed, thereby making the saddle bag much more stable, and less likely to be damaged due to falling over. Additionally, the saddle bag stabilizer is now positioned between the base of the saddle bag and the surface the saddle bag will be placed on, protecting the bottom surface of the saddle bag from damage from the surface the saddle bag has been placed on.

One general aspect includes a stabilization system for use with a luggage of a vehicle. The stabilization system also includes at least one contact pad positioned on a bottom side of the luggage. The system also includes where the at least one contact pad is adapted to position the luggage in an upright and stable position.

Implementations may include one or more of the following features. The stabilization system where the at least one contact pad may include a plurality of contact pads. The at least one of the plurality of the contact pads may include a preselected length. The preselected length is adjustable. The plurality of the contact pads are may include of any of plastic, rubber, and foam. The luggage has a first end and a second end and where the plurality of contact pads may include a first pair of divergent feet positioned on the bottom side proximate the first end and a second pair of divergent feet positioned on the bottom side proximate the second end and where the first pair of divergent feet and the second pair of divergent feet are adapted to position the luggage in the upright and stable position on a relatively flat surface. The first pair of divergent feet and the second pair of divergent feet are integral to the luggage. The relatively flat surface may include the ground and where the first pair of divergent feet and the second pair of divergent feet position the bottom side of the luggage above the ground. The at least one contact pad may include a stabilizing base structure, and where the stabilizing base structure is removably fixed to the bottom side of the luggage. The stabilizing base structure is removably fixed to the bottom side of the luggage with any of an adhesive, a hook and loop system, or a fastener. The bottom side of the luggage has a first width and the stabilizing base structure has a second width and where the second width is greater than the first width. The luggage is a saddle bag and the vehicle is a motorcycle.

One general aspect includes a luggage stabilization system for a piece of luggage for a vehicle. The luggage stabilization system also includes at least one stabilization feature positioned proximate a bottom of the piece of luggage; and the at least one stabilization feature is adapted to position the piece of luggage in an upright and stable position on a relatively flat horizontal surface.

Implementations may include one or more of the following features. The luggage stabilization system where the relatively flat horizontal surface may include the ground and where at least one stabilization feature is adapted to position the piece of luggage in an upright and stable position on a relatively flat horizontal surface and to position the bottom of the piece of luggage above the ground. The at least one stabilization feature is may include of any of plastic, rubber, and foam. The at least one stabilization feature may include a plurality of contact pads. Each of the plurality of contact pads may include a preselected length. The preselected length is adjustable. The at least one stabilization feature may include a stabilizing base structure and where the stabilizing base structure is removably fixed to the bottom of the piece of luggage. The stabilizing base structure is removably fixed to the bottom of the piece of luggage with any of an adhesive, a hook and loop system, or a fastener. The bottom of the piece of luggage has a first width and the stabilizing base structure has a second width and where the second width is greater than the first width. The piece of luggage has a first end and a second end and where the at least one stabilization feature may include a first pair of divergent feet positioned on the bottom of the piece of luggage proximate the first end and a second pair of divergent feet positioned on the bottom of the piece of luggage proximate the second end and where the first pair of divergent feet and the second pair of divergent feet are adapted to position the piece of luggage in the upright and stable position on the relatively flat horizontal surface. The first pair of divergent feet and the second pair of divergent feet are integral to the piece of luggage. The relatively flat horizontal surface may include the ground and where the first pair of divergent feet and the second pair of divergent feet position the bottom of the piece of luggage above the ground. The piece of luggage is a saddle bag.

One general aspect includes a method of stabilizing a piece of luggage for a vehicle. The method also includes selecting at least one stabilization feature having a predetermined profile; positioning the at least one stabilization feature proximate a bottom of the piece of luggage, and where the predetermined profile is chosen to position the piece of luggage in an upright and stable position on a relatively flat horizontal surface.

Implementations may include one or more of the following features. The method where the relatively flat horizontal surface may include the ground, the method further positioning the bottom of the piece of luggage above the ground. The at least one stabilization feature is may include of any of plastic, rubber, and foam. The at least one stabilization feature may include a plurality of contact pads and where the predetermined profile is may include of the plurality of contact pads. Each of the plurality of contact pads may include a preselected length. The preselected length is adjustable. The at least one stabilization feature is a stabilizing base structure having a first width and where the bottom of the piece of luggage has a second width and where the first width is wider than the second width, and removably fixing the stabilizing base structure to the bottom of the piece of luggage.

One general aspect includes a method of retrofitting a piece of luggage for a vehicle with a stabilizing system. The method also includes selecting the piece of luggage; selecting at least one stabilization feature having a predetermined profile, positioning the at least one stabilization feature proximate a bottom of the piece of luggage, and choosing the predetermined profile to position the piece of luggage in an upright and stable position on a relatively flat horizontal surface.

Implementations may include one or more of the following features. The method where the relatively flat horizontal surface may include the ground, the method further positioning the bottom of the piece of luggage above the ground. The at least one stabilization feature is may include of any of plastic, rubber, and foam. The at least one stabilization feature may include a plurality of contact pads and where the predetermined profile is may include of the plurality of contact pads. Each of the plurality of contact pads may include a preselected length. The preselected length is adjustable. The at least one stabilization feature is a stabilizing base structure having a first width and where the bottom of the luggage has a second width and where the first width is wider than the second width, and removably fixing the stabilizing base structure to the bottom of the piece of luggage.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side view of a vehicle with detachable saddle bags of the prior art.

FIG. 2 is a perspective view of a saddle bag with a stabilizing system in accordance with certain embodiments of the present disclosure.

FIG. 3 is an end view of a stabilizing system positioned on a bottom side of saddle bag in accordance with certain embodiments of the present disclosure.

FIG. 4 is a perspective view of a saddle bag with a stabilizing system in accordance with certain embodiments of the present disclosure.

FIG. 5 is a section view of the saddle bag of FIG. 4 taken along cut line 5-5 in accordance with certain embodiments of the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

The stabilizer systems of this disclosure relate to detachable luggage for “open air” type vehicles, including trikes, quads, motorcycles, mopeds and bicycles. The disclosure is particularly directed towards a luggage stabilizer which is put into use when the detachable luggage is detached and placed on the ground or working surface such as a bench or table. The luggage stabilizer is positioned on the bottom, outside, surface of the detachable luggage such that when placed on the ground or a working surface such as a bench or table, the outside bottom surface is protected from direct contact with the ground or working surface and potential damage due to such contact. Additionally, due to the novel shape of embodiments of the luggage stabilizer of the present disclosure, the original footprint of the prior art detachable luggage is increased such that the luggage is less susceptible to tipping over and causing damage to the painted and aesthetic surfaces and other deleterious effects as described herein above. As will be described in more detail immediately herein below, the detachable saddle bag stabilizer system of the present invention ameliorates the problem of damaging the detachable saddle bag when removed from the wheeled vehicle and placed on a surface as is common practice while performing certain cleaning, maintenance, and adjustment activities to the wheeled vehicle.

Embodiments of the present disclosure referring to FIG. 2 include luggage having a stabilization system positioned on a bottom side. The stabilization system includes stabilization features such as profiles and contact pads as will be described in more detail herein after. In certain embodiments of the present disclosure the stabilization system is an integral part of the luggage itself. In other embodiments of the present disclosure the stabilization system can retrofitted to an existing piece of luggage. In a certain embodiment the stabilization system is semi permanently attached to the base of a saddle bag with double sided adhesive strips. The adhesive strips provide enough fixing strength such that the stabilization system will remain attached to the saddle bag as long as is desired by the user, but can be removed if desired without damage to the saddle bag by using known methods that leave the saddle bag with its original painted surface intact. In other embodiments the stabilization system is semi permanently attached to the base of a saddle bag with hook and loop type fastener system. The hook and loop system provide enough fixing strength such that the stabilization system will remain attached to the saddle bag as long as is desired by the user, but can be removed if desired without damage to the saddle bag by using known methods that leave the saddle bag with its original painted surface intact.

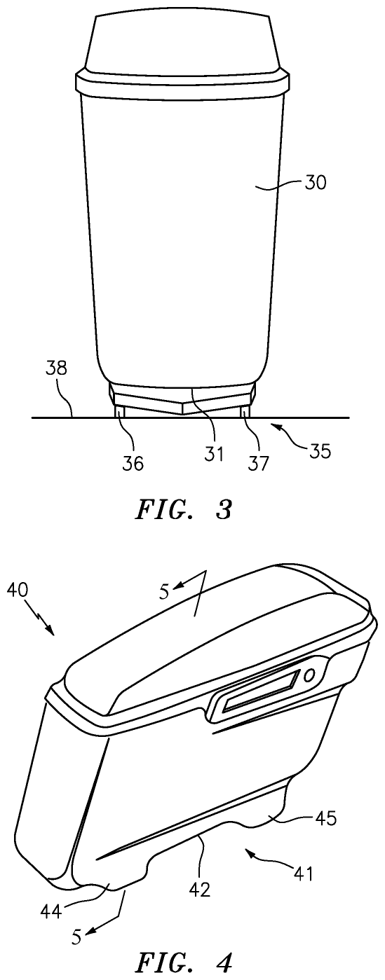

In another embodiment of the present disclosure and with reference to FIG. 3, stabilizer system 35 is comprised of a plurality of contact pads 36, 37 (and others not shown) attached to the bottom 31 of the luggage to provide a saddle bag stabilizer system for a detachable saddle bag 30. This particular embodiment includes retrofitting an existing saddle bag 30 by drilling of mounting holes through the base of the detachable saddle bag and the application of a gasket system for each drilled hole location to prevent moisture and other contamination from entering the detachable saddle bag while in use on the vehicle. The height of each contact pad 36, 37 is chosen to provide a stable position of the saddle bag when detached and placed on a relatively flat surface 38.

In one embodiment of the present disclosure the stabilization system is relatively flat, and when positioned on the bottom of a saddle bag the stabilization system provides a larger perimeter and effective cross section, i.e. a larger footprint, than the base of the detachable saddle bag. The larger perimeter of the installed stabilization system makes the saddle bag less likely to fall over and damage the painted saddle bag exterior, and provides a protective barrier between the base of the saddle bag and the surface the saddle bag is placed on during common cleaning, maintenance, and adjustment activities of the vehicle.

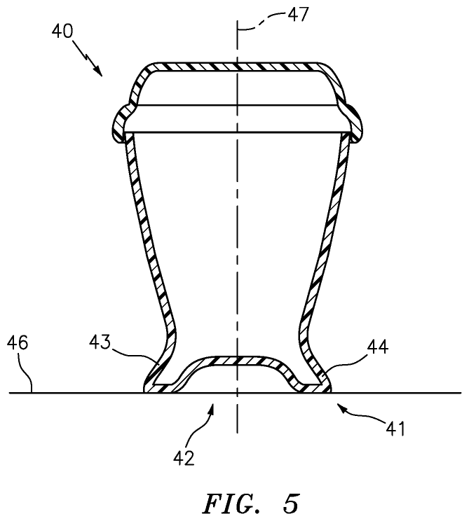

An additional embodiment disclosed with reference to FIGS. 4, 5 herein is to provide a detachable saddle bag design with integral saddle bag stabilizer functionality without the need for adding an additional part and/or assembly. The stabilization system comprises a combination of at least two, and up to an including four, stand offs positioned near various corners of the base of the detachable saddle bag. In certain embodiments the stand offs can be molded into the saddle bags during the initial manufacturing process with the addition of wear resistant or cushioning tips. In other embodiments, the standoffs can be comprised of plastic, rubber, or foam designed to be permanently or semi permanently for replacement if damaged or worn to the at least 2 corners. The stand offs, also referred to herein as contact pads, can support the detachable saddle bag as wide and long as practicably possible given the envelope of the base of the detachable saddle bag such that the most stabilization is provided for a given detachable saddle bag geometry. Additionally, since the stand offs are supporting the detachable saddle bag some height above the surface the detachable saddle bag is being place on, the underside base of the saddle bag is thereby also protected. In other embodiments, if the detachable saddle bag geometry does not allow for packaging a permanently placed stand off at one or more required corners due to the accommodating other wheeled vehicle geometry such as exhaust pipes and/or shock absorbers or other wheeled vehicle componentry, a retractable or rotatable stand off is provided such that it can be deployed to its stabilizing position once the detachable saddle bag has been removed, and is now clear of the wheeled vehicle componentry causing the clearance interference if not retractable, rotatable or removable.

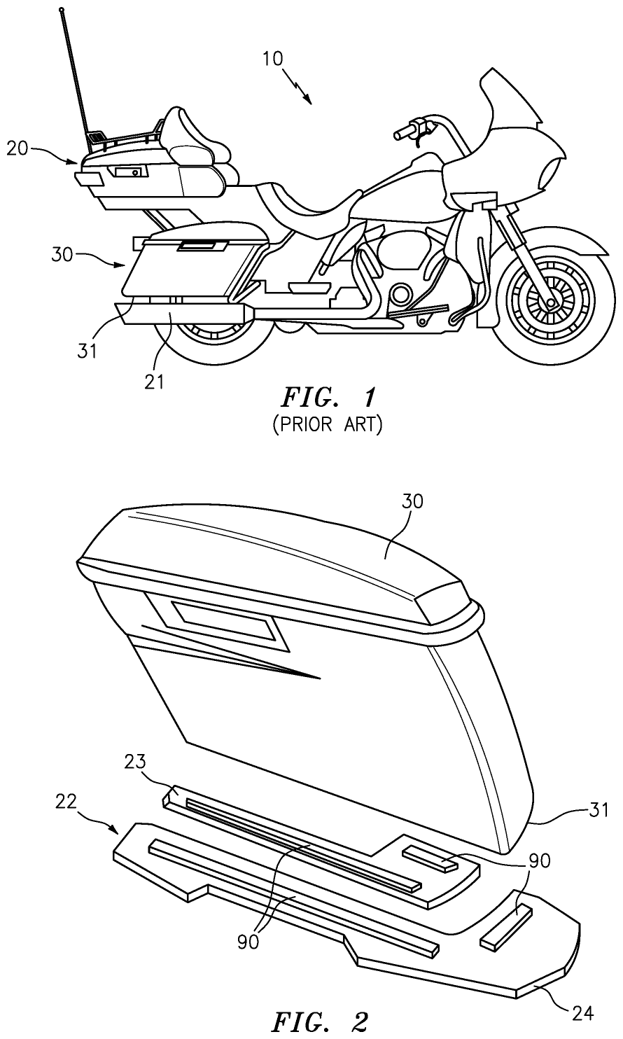

Referring to FIG. 1, there is shown vehicle, a motorcycle 10 in this example, with detachable saddle bag 30 of the prior art installed in a normal fashion. Motorcycle 10 includes a trunk 20 and exhaust pipe 21. Saddle bag 30 typically has a mirrored version on the opposite of motorcycle 10 (not shown) and is of the hard-side variety of saddlebag. In such a configuration, the bottom 31 of saddle bag 30 is contoured, partially for aesthetic reasons and partially to avoid contact with exhaust pipe 21 (or other vehicle components such as frame and suspension parts). As described herein above, it is the contoured bottom 31 of saddle bag 30 that makes it unstable when detached from motorcycle 10 and placed on a flat surface.

Referring next to FIG. 2, there is shown a stabilizing base system 22 comprised of inside stabilizing base structure 23 and outside stabilizing base structure 24 for attachment to bottom 31 of saddle bag 30. Inside stabilizing base structure 23 and outside stabilizing base structure 24 include adhesive strips 90 positioned on a topside thereof for attachment to bottom side of saddle bag 30. Inside stabilizing base structure 23 and outside stabilizing base structure 24 can be manufactured from any structurally appropriate material such as wood, metal, plastic, or carbon fiber and fiberglass composites using common manufacturing practices. One embodiment comprises plastic material and CNC machining as the manufacturing process. It would be understood that inside stabilizing base structure 23 and outside stabilizing base structure 24 can be machined or molded or cast or forged or hand built up by hand of composite materials or fabricated using current 3D printing technology. Regardless of the material or method of manufacture, it should be understood by those skilled in the art that when retrofitted to bottom 31 of saddle bag 30, inside stabilizing base structure 23 and outside stabilizing base structure 24 are adapted to create a profile that that stabilizes the saddle bag when detached from motorcycle 10 and placed on a relatively flat horizontal surface such as the ground. In embodiments where bottom 31 of saddle bag 30 is relatively flat, inside stabilizing base structure 23 and outside stabilizing base structure 24 can also comprise flat structures with the stabilization feature comprising a wider base than the bottom of the saddle bag. In addition, the profile of inside stabilizing base structure 23 and outside stabilizing base structure 24 can be integral to the inside stabilizing base structure and the outside stabilizing base structure or the profile can comprise contact pads (36, 37 in FIG. 3) that are positioned on the bottom of the structures and proximate a bottom of saddle bag 30. In the embodiment shown, stabilizer base system 22 is comprised of multiple pieces to accommodate certain features (not shown) on the bottom 31 of saddle bag 30. It is within the scope of the present disclosure that stabilizer base system 22 can be comprised of a single structural element or multiple structural elements. Adhesive strip 90 can comprise any commercially available double-sided pressure sensitive adhesive strip. Such double-sided adhesive comes in rolls of strip of various widths to be cut to length for installation, individual strips of a specified length and width and ready for application, or in sheet form where variable shapes can be configured via stamping or cutting. The present embodiment utilizes rolls of strips of a preselected width, that are readied for installation to inside stabilizing base structure 23 and outside stabilizing base structure 24 by being cut to length for the application. As discussed herein above, a hook and loop type strip fastener can be used as an alternative to double sided pressure sensitive adhesive strip. The shape and make up of inside stabilizing base structure 23 and outside stabilizing base structure 24 is preselected for any particular saddle bag 30. In the present embodiment, stabilizing system 35 is designed for a particular model year of a saddle bag design. It should be understood by those skilled in the art that the shape and number of structural elements of stabilizer base system 22 will change slightly as the bottom surface of saddle bag 30 differ from design to design. However, it is common among the variants of stabilizing system 35 the common performing requirement remains the same regardless of saddle bag 30 design variations being a wider resultant base than the base of saddle bag 30 without stabilizer base system 22 and a protective barrier is provided between the base of saddle bag 30 and the surface it is being placed on. Adhesive strip 90 has protective backing on both sides of adhesive strip 90. Each protective backing remains in place during shipping, storage, or while in inventory, but it is readily removed to expose the adhesive on one or both sides of adhesive strip 90.

Now with reference to FIG. 3, there is shown shows stabilizing system 35 attached to and installed on the bottom 31 of the base of saddle bag 30 comprised of contact pads 36, 37 contacting a relatively flat surface 38 (i.e., a ground surface). The stabilization feature is comprised of contact pads 36, 37 that form a predetermined profile to position saddle bag 30 in an upright and stable position on a relatively flat surface. The lengths of contact pads 36, 37 are preselected lengths and are chosen to position and accommodate the contour of the bottom 31 of saddle bag 30 such that when the saddle bag with stabilizing system 35 is placed relatively flat surface 38 the saddle bag is level, upright and stable. Although FIG. 3 shows an end view of saddle bag 30, stabilizing system 35 is comprised of a plurality of contact pads in addition to contact pads 36, 37, and the opposite end of the saddle bag can have contact pads of similar or differing heights than those of contact pads 36, 37 wherein the heights are chosen to laterally stabilize the saddle bag, maintain the saddle bag bottom surface above the ground and prevent a rocking motion along the length of the saddle bag. Contact pads 36, 37 can be comprised of any suitable material and can include a composite of materials such as rubber, plastic and metal. As described herein before, stabilizing system 35 can be retrofitted to an existing saddle bag 30 wherein contact pads 36, 37 can be bolted to bottom 31 of saddle bag 30 using appropriate bolts and gaskets. In addition, contact pads 36, 37 can be co-manufactured with saddle bag 30 and thus be integral to the saddle bag itself. In certain embodiments, contact pads 36, 37 can have a predetermined length and the predetermined length can be adjustable in length either statically (an adjuster screw for example) or dynamically (a spring for example).

In other embodiments of the present disclosure, a stabilizing system can comprise a molded structure wherein in a top side of the structure conforms to the bottom side of saddle bag 30 and the bottom side of the structure is adapted to position the saddle bag in an upright and stable position when placed on the ground. In other embodiments, a stabilization system is co-manufactured with a saddle bag. This embodiment is best shown with reference to FIGS. 4, 5 wherein saddle bag 40 includes stabilizing system 41 integral to, and co-manufactured with, the saddle bag along the bottom 42. Stabilizing system 41 includes as a stabilization feature a plurality of feet including inside rear foot 43, outside rear foot 44, outside front foot 45 and inside front foot (not shown). Inside rear foot 43 and outside rear foot 44 are a first pair of divergent feet, in that they diverge from centerline 47, and are positioned proximate the rear end of saddle bag 40. Inside front foot 45 and outside front foot are a second pair of divergent feet, in that they diverge from centerline 47, and are positioned proximate the rear end of saddle bag 40. The plurality of feet of stabilizing system 41 are positioned along the bottom 42 of saddle bag 40 and create a predetermined profile such that when the saddle bag is positioned on a relatively flat surface 46 the saddle bag remains upright and stable positioned along its centerline 47. In addition, the feet are positioned divergently outwardly from the outside profile of saddle bag 40. It should be apparent to those skilled in the art that stabilizing system 41 positions saddle bag 40 along its centerline 47 and provides a wide foot print wherein the divergent feet position the saddle bag in an upright and stable position and thus provides a stable platform that elevates the saddle bag above a relatively flat surface when the saddle bag is detached from the vehicle. It should be further appreciated that stabilization system 41 includes features that avoid structures, such as exhaust pipe 21 (FIG. 1) as well as structural and suspension components of motorcycle 10, when saddle bag 40 is installed on a vehicle. Saddle bag 40 can be manufactured from any known method such as injection molding, blow molding, stamping and the like and can further be comprised of any suitable material.

What is claimed is:

1. A stabilization system for use with a luggage of a vehicle comprising;
at least one contact pad positioned on a bottom side of the luggage; and
wherein the at least one contact pad is adapted to position the luggage in an upright and stable position.

2. The stabilization system of claim 1 wherein the at least one contact pad comprises a plurality of contact pads.

3. The stabilization system of claim 2 wherein the at least one of the plurality of the contact pads comprises a preselected length.

4. The stabilization system of claim 3 wherein the preselected length is adjustable.

5. The stabilization system of claim 2 wherein the plurality of the contact pads are comprised of any of plastic, rubber, and foam.

6. The stabilization system of claim 1 wherein the at least one contact pad comprises a stabilizing base structure, and wherein the stabilizing base structure is removably fixed to the bottom side of the luggage.

7. The stabilization system of claim 6 wherein the stabilizing base structure is removably fixed to the bottom side of the luggage with any of an adhesive, a hook and loop system, or a fastener.

8. The stabilization system of claim 7 wherein the bottom side of the luggage has a first width and the stabilizing base structure has a second width and wherein the second width is greater than the first width.

9. The stabilization system of claim 2 wherein the luggage has a first end and a second end and wherein the plurality of contact pads comprise a first pair of divergent feet positioned on the bottom side proximate the first end and a second pair of divergent feet positioned on the bottom side proximate the second end and wherein the first pair of divergent feet and the second pair of divergent feet are adapted to position the luggage in the upright and stable position on a relatively flat surface.

10. The stabilization system of claim 9 wherein the first pair of divergent feet and the second pair of divergent feet are integral to the luggage.

11. The stabilization system of claim 9 wherein the relatively flat surface comprises the ground and wherein the first pair of divergent feet and the second pair of divergent feet position the bottom side of the luggage above the ground.

12. The stabilization system of claim 1 wherein the luggage is a saddle bag and the vehicle is a motorcycle.

13. A luggage stabilization system for a piece of luggage for a vehicle comprising:
at least one stabilization feature positioned proximate a bottom of the piece of luggage; and
the at least one stabilization feature is adapted to position the piece of luggage in an upright and stable position on a relatively flat horizontal surface.

14. The luggage stabilization system of claim 13 wherein the relatively flat horizontal surface comprises the ground and wherein at least one stabilization feature is adapted to position the piece of luggage in an upright and stable position on a relatively flat horizontal surface and to position the bottom of the piece of luggage above the ground.

15. The luggage stabilization system of claim 13 wherein the at least one stabilization feature is comprised of any of plastic, rubber, and foam.

16. The luggage stabilization system of claim 15 wherein the at least one stabilization feature comprises a plurality of contact pads.

17. The luggage stabilization system of claim 16 wherein each of the plurality of contact pads comprises a preselected length.

18. The luggage stabilization of claim 17 wherein the preselected length is adjustable.

19. The luggage stabilization system of claim 13 wherein the at least one stabilization feature comprises a stabilizing base structure and wherein the stabilizing base structure is removably fixed to the bottom of the piece of luggage.

20. The luggage stabilization system of claim 19 wherein the stabilizing base structure is removably fixed to the bottom of the piece of luggage with any of an adhesive, a hook and loop system, or a fastener.

21. The luggage stabilization system of claim 20 wherein the bottom of the piece of luggage has a first width and the stabilizing base structure has a second width and wherein the second width is greater than the first width.

22. The luggage stabilization system of claim 13 wherein the piece of luggage has a first end and a second end and wherein the at least one stabilization feature comprises a first pair of divergent feet positioned on the bottom of the piece of luggage proximate the first end and a second pair of divergent feet positioned on the bottom of the piece of luggage proximate the second end and wherein the first pair of divergent feet and the second pair of divergent feet are adapted to position the piece of luggage in the upright and stable position on the relatively flat horizontal surface.

23. The luggage stabilization system of claim 22 wherein the first pair of divergent feet and the second pair of divergent feet are integral to the piece of luggage.

24. The luggage stabilization system of claim 22 wherein the relatively flat horizontal surface comprises the ground and wherein the first pair of divergent feet and the second pair of divergent feet position the bottom of the piece of luggage above the ground.

25. The luggage stabilization system of claim 13 wherein the piece of luggage is a saddle bag.

26. A method of stabilizing a piece of luggage for a vehicle comprising:
selecting at least one stabilization feature having a predetermined profile;
positioning the at least one stabilization feature proximate a bottom of the piece of luggage; and
wherein the predetermined profile is chosen to position the piece of luggage in an upright and stable position on a relatively flat horizontal surface.

27. The method of claim 26 wherein the relatively flat horizontal surface comprises the ground, the method further positioning the bottom of the piece of luggage above the ground.

28. The method of claim 26 wherein the at least one stabilization feature is comprised of any of plastic, rubber, and foam.

29. The method of claim 28 wherein the at least one stabilization feature comprises a plurality of contact pads and wherein the predetermined profile is comprised of the plurality of contact pads.

30. The method of claim 29 wherein each of the plurality of contact pads comprises a preselected length.

31. The method of claim 30 wherein the preselected length is adjustable.

32. The method of claim 26 wherein the at least one stabilization feature is a stabilizing base structure having a first width and wherein the bottom of the piece of luggage has a second width and wherein the first width is wider than the second width; and
removably fixing the stabilizing base structure to the bottom of the piece of luggage.

33. A method of retrofitting a piece of luggage for a vehicle with a stabilizing system, the method comprising:
selecting the piece of luggage;
selecting at least one stabilization feature having a predetermined profile;
positioning the at least one stabilization feature proximate a bottom of the piece of luggage; and
choosing the predetermined profile to position the piece of luggage in an upright and stable position on a relatively flat horizontal surface.

34. The method of claim 33 wherein the relatively flat horizontal surface comprises the ground, the method further positioning the bottom of the piece of luggage above the ground.

35. The method of claim 33 wherein the at least one stabilization feature is comprised of any of plastic, rubber, and foam.

36. The stabilization system of claim 35 wherein the at least one stabilization feature comprises a plurality of contact pads and wherein the predetermined profile is comprised of the plurality of contact pads.

37. The stabilization system of claim 36 wherein each of the plurality of contact pads comprises a preselected length.

38. The stabilization system of claim 37 wherein the preselected length is adjustable.

39. The method of claim 33 wherein the at least one stabilization feature is a stabilizing base structure having a first width and wherein the bottom of the luggage has a second width and wherein the first width is wider than the second width; and
removably fixing the stabilizing base structure to the bottom of the piece of luggage.
